(19) United States
(12) Patent Application Publication
(10) Pub. No.: US 2022/0020229 A1
(43) Pub. Date: Jan. 20, 2022

(54) SYSTEM AND METHOD FOR MOBILE TOLL CALCULATION AND PAYMENT

(71) Applicant: Transurban Mobile LLC, Alexandria, VA (US)

(72) Inventors: Christopher T. HIGGINS, Alexandria, VA (US); William MAYVILLE, Alexandria, VA (US); Christine MANLEY, Alexandria, VA (US)

(73) Assignee: Transurban Mobile LLC, Alexandria, VA (US)

(21) Appl. No.: 17/374,557

(22) Filed: Jul. 13, 2021

Related U.S. Application Data
(60) Provisional application No. 63/051,563, filed on Jul. 14, 2020.

(51) Int. Cl. G07B 15/06; G06Q 30/02; G06Q 20/32; G06Q 20/40; G06F 16/29; H04L 29/08

(52) U.S. Cl. CPC G07B 15/063; G06Q 30/0284; G06Q 20/3224; G06Q 20/4015; G01S 19/51; G06F 16/29; H04L 67/306; H04L 67/18; G06Q 20/326

(57) ABSTRACT

A mobile tolling application and system for allowing users to pay tolls through the mobile application running on a user mobile device are described. In particular, a mobile application running on a mobile device having a GPS, GLONASS, satellite, or other location receiver receives information regarding the location of the mobile device, compares the location information to known map way points, and sends the location and applicable travel information to a remote server. The remote server forms a route traveled by the vehicle based on received information from the mobile application, retrieves pricing information for tolls on the formed route, and provides calculated tolling information to the mobile application. Users can then select to pay the tolls through the mobile application.

### RELATED APPLICATIONS

This application claims priority to U.S. provisional application 63/051,563 filed on Jul. 14, 2020, the contents of which are incorporated by reference in their entirety.

### TECHNICAL FIELD

The present invention is directed to a system and method for calculating and processing toll payments using a mobile device and application running on a mobile device. In particular, a mobile application running on a mobile device having a GPS, GLONASS, satellite, or other location receiver receives information regarding the location of the mobile device, compares the location information to known map way points, and sends the location and applicable travel information to a remote server. The remote server forms a route traveled by the vehicle based on received information from the mobile application, retrieves pricing information for tolls on the formed route, and provides calculated tolling information to the mobile application. Users can then select to pay the tolls through the mobile application.

### BACKGROUND OF THE INVENTION

Currently, many toll roads are switching from a manual, cash-based toll collection system to cashless electronic tolling systems. However, many cashless toll systems require a user to have a special tolling tag, such as an RFID device, in their vehicle which is sensed when a user passes a tolling point that has sensors to read the RFID device. In operation, these devices are detected at toll gantries or toll booths located along roads, and tolls are deducted from an account linked to the tolling tag. The toll prices may be a fixed toll for passing that point, or may be determined based on the distance a user traveled before coming to the tolling point by detecting the same tolling tag at multiple points along a route. However, errors can occur if the signal from the RFID device is not captured, and vehicles that do not pass by the points with sensors to read the RFID devices may avoid the tolls even if they travel on routes where toll collection would be appropriate.

Current mobile tolling systems may require that all location information from a phone is captured and sent during a trip. This can cause issues with phone battery power and data usage, as the phone must continuously track its location. In addition, existing mobile tolling solutions that base tolling rates and calculations of incurred tolls solely on all captured location data may cause false triggers of toll charges when tolls may be based not only on location, but also on, for example, direction, speed, or particular lane. What is needed is a system and method that allow for flexible toll payment without the dedicated RFID hardware tags and tolling gantries, and that provide for flexibility in pricing, toll payment, and toll verification.

### SUMMARY OF THE INVENTION

The present application is directed to a system and method for implementing toll collection through a mobile application run on a user's mobile device. Users may download the mobile application onto a user mobile device, and complete a registration process that associates the user with a particular account. This account may include information regarding the user identity, user vehicles, user license plate numbers, and user payment information. The user payment information may be, for example, a credit card number, bank account number, or electronic payment service information. The mobile application, through the communication interfaces in the mobile device, transmits this information to a mobile tolling system server which registers the user within the system and allows the user to then pay tolls through the mobile application.

The mobile tolling system server may comprise one or more servers at a single or multiple locations. The mobile tolling system server contains a database of registered users, a database of roads and road segments, and databases of tolling rules that indicate when a toll will apply. The server further determines pricing information, in real-time, to present to users of the mobile app providing details on the estimated tolls for a particular route, the price of tolls owed due to a route currently or previously traveled, and pricing for upcoming tolls as a vehicle travels along a route. To determine this pricing information, the server may contain a database of toll pricing for particular routes and road segments, and may further communicate with third-party systems that contain toll pricing information. For example, the mobile tolling system server may communicate with state tolling agencies, private tolling agencies, and databases that monitor and provide real-time toll prices for various road segments.

In use, the mobile application accesses the GPS or other location receiver in the mobile device, and sends location information to a remote server. The mobile application accesses mapping information, and determines waypoints or check-in zones that are likely to be encountered along a route traveled by the vehicle. The mobile application monitors its location, and when it approaches a known waypoint or check-in zone, can cause the phone to more accurately track its location when it nears a waypoint or check-in. For example, the mobile application may increase the location processing and location receiver functionality of the phone near those locations. When it is determined that the mobile device, and therefore the vehicle, has entered a geolocation check-in zone, the system registers a vehicle check-in for that geolocation check-in zone. The mobile application tracks the waypoints and check-ins that has entered, and sends this information regarding the predetermined geolocation check-in zones that it has entered to a remote server. The remote server monitors the received check-ins from the mobile application, and determines trips or routes based on the check-ins. When the vehicle registers check-ins at one or more geolocation check-in zones, a trip is formed and compared to the tolling database to determine if one or more tolls should be paid. Formation of trips is based on, for example, a determine direction of travel of the vehicle, origin and destination of travel, number and location of vehicle check-ins, and the time elapsed for the entire trip or time between vehicle check-ins at different geolocation check-in zones. During travel, the user may be notified that they are approaching another geolocation check-in zone which would complete a trip and trigger a required toll payment. To determine the required toll payment, the system may communicate with a plurality of different public and private tolling agencies. The system may have direct communication with these tolling agencies to receive real-time or current toll pricing information, and may further utilize a web scraper and application programming interface to search websites of tolling authorities and pull current toll pricing and rates in real-time.

In addition to sending check-in information to a remote server for formation of trips and calculation of tolls, the mobile application itself may determine routes and tolling pricing. For example, the mobile tolling application may load maps in the area of the user, and load tolling information for any tolls within a predetermined or selected distance from the current location of the phone. The mobile application may also allow a user to plan a route, and then load the tolling information for that route prior to starting. Then, the mobile application itself may track the location, determine routes, and determine tolling information as described above. The mobile application may further request tolling information, or check for updates to tolling prices, at any time. For example, the mobile application may be configured to check tolling prices at predetermined time intervals, or upon request from the user.

Using this tolling information, the system may communicate with the appropriate tolling agencies operating or having authority over the tolls on the routes traversed by the mobile application user's vehicle. Based on information received from the mobile application, the mobile application itself or a server in communication with the mobile application may complete a transaction to pay any incurred tolls, using the payment information for the user provided in the mobile application.

In order to determine that toll transactions assigned to a user of the mobile application are accurate, the system may include an automated trip simulation feature. Using the automated trip simulation feature, virtual routes of travel with simulated traffic may be created, with desired check-in locations included along the routes. A path for a simulated vehicle is defined, and the simulated vehicle generates check-ins that are received by a system backend server, which then forms the trips based on the check-in information. The system checks the simulated trip, and validates that the desired check-ins were correctly registered and that the trip was properly formed. Once a simulated trip for a particular route is validated, the check-in locations are validated in the system and can be used for tolling calculations for real-world trips taken by users.

The mobile application may further include a trip planning feature, allowing users to input starting and ending locations. The trip planning feature in the mobile application then generates one or more potential routes for the user to take between the starting and ending locations, and determines any toll locations or potential tolls that would be incurred on each of the potential routes. The trip planning feature may further pull in toll pricing information for each of the routes, and display the tolls required on each route. Thus, a user can determine which route to take based on, for example, distance, time, and amount of toll charges that would be incurred.

### BRIEF DESCRIPTION OF THE DRAWINGS

FIG. 1 is an illustration of an exemplary mobile tolling system.

FIG. 2A depicts the processing steps to register a user with the mobile tolling application service.

FIGS. 2B-2D depict exemplary mobile application user interfaces provided to a user of the mobile application during and after the registration process.

FIG. 3 illustrates a use of the mobile application for traversing a road with an electronic tolling point.

FIGS. 4A and 4B illustrate examples of geolocation check-in zones that may be used to form a route traveled by a vehicle and assess appropriate tolling charges.

FIG. 5 illustrates an exemplary formed trip route between a starting location and an ending location.

FIG. 6 is an illustration of an exemplary mobile application user interface presented to a user following completion of a trip with incurred toll charges.

FIG. 7 depicts the processing for forming a trip as a user of the mobile application traverses a route in a vehicle.

FIG. 8 depicts the processing for conducting asset transactions to pay tolls incurred by users of the mobile application to the appropriate tolling authorities.

### DETAILED DESCRIPTION

A system and method for providing mobile application toll transactions are disclosed. Users download a mobile application onto a mobile device, and register with a mobile tolling service. The mobile tolling service creates an account for each user, with the account including identifying information for the user including user name, vehicle information, and payment information. Once a user is registered with the mobile tolling service, the user can activate the mobile application on a mobile device, and use the mobile application to pay tolls. These tolls may be paid directly to the appropriate tolling authorities from the user, or the mobile tolling service may pay the tolls to the tolling authority and collect appropriate fees from the mobile application user to cover payment of the tolls. The mobile tolling service, through the mobile application, may allow a user to pay various types of tolls. For example, the mobile tolling service may allow for flexible tolling and pricing based on trips taken by a user from a starting location to an ending location. This trip-based tolling may include pulling location information from a GPS, GLONASS, or other location receiver in the mobile device implementing the mobile application, processing the location information to determine check-ins of the vehicle at locations along the travel path, forming a trip based on the determined check-ins, and determining toll pricing for the formed trip. The determined toll charges incurred are then communicated to the user, either during or after the trip, and the user may select to pay the tolls through the mobile application. The mobile application may also allow users to pre-plan a trip, and select to submit a payment for all tolls that will be incurred in advance. As the vehicle carrying the mobile device completes the trip, the mobile application may track and form the trip taken to verify that the pre-planned trip was followed and all necessary tolls are paid. Users may also use the mobile application to pay set tolls at designated check-points, such as at toll booths or electronic tolling gantries at set locations, such as along highways, at bridges, at exit ramps, and at entrances or exits to high-speed or express travel lanes.

The mobile application may provide a plurality of user interfaces to the user, allowing a user to register with the application, set up and edit a user profile, review paid tolls, create and view planned trips and toll pricing information, view receipts of paid tolls, and receive notifications related to trips or toll pricing. The mobile application may have addition interfaces for a user to set preferences, check frequently asked questions, or request customer service through a voice, chat or messaging interface.

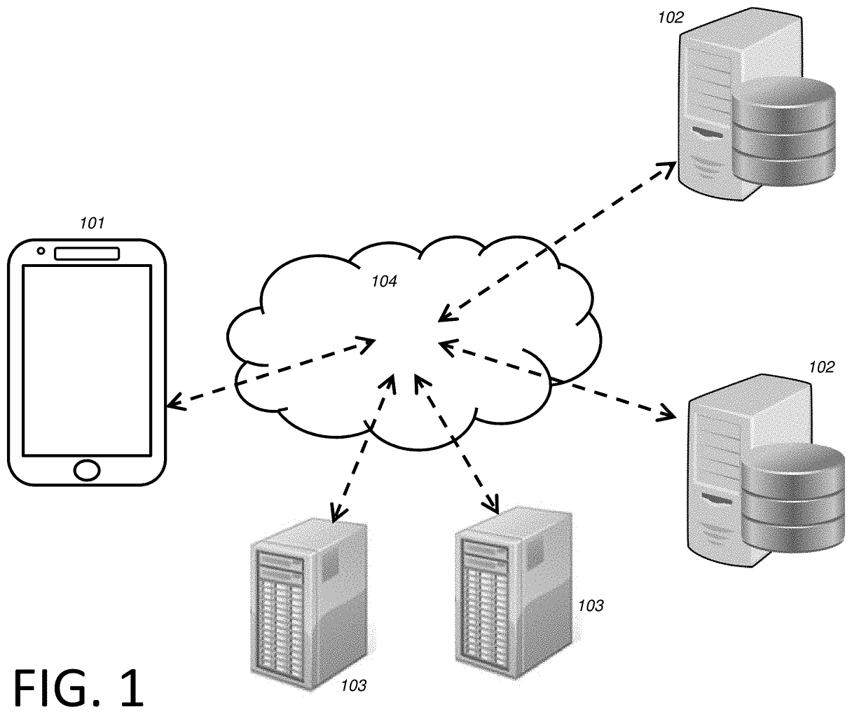

FIG. 1 illustrates an exemplary mobile tolling system used to implement the features of the mobile tolling application. As shown in FIG. 1, users may download the mobile application to a user mobile device 101. This user mobile device may be, for example, a smartphone, tablet, PDA, or smartwatch having a processor, computer readable media that stores software and application programs for execution by the processor, wireless communication interface and at least one location receiver such as a GPS or GLONASS receiver. The user device may communicate with one or more mobile tolling system servers 102, and one or more data sources 102. The mobile tolling system servers 102 may provide backend support for the mobile tolling application run on the user device 101. These mobile tolling system servers may maintain a database of registered users and user information, a database of roads and routes, a database of tolling information, and toll pricing information. The mobile tolling system servers 102 may also be configured to conduct tolling transactions directly with the users, with third-party tolling authorities, and with financial institutions. As shown, the user devices 101 and mobile tolling system servers may also be in communication with a plurality of data sources 103. These data sources 103 may be, for example, electronic databases or web sites including road and map information, toll information, toll service authorities, and toll pricing. Data sources may also include electronic tolling gantries, toll booths, and other roadside toll devices. The user devices 101, mobile toll system servers 102, and data sources 103 may communicate over a wireless network 104. Network 106 may include, for example, one or more of the internet, a wide area network, a local area network, near field communications such as Bluetooth or RFID, a cellular communication network, mobile telecommunications networks, radio, satellite communication networks, or any combination of wired and wireless communication networks. As explained herein, when a user executing the mobile tolling application on a user mobile device 101 traverses a route in a vehicle, the mobile application, through the user device, communicates with one or more of the mobile tolling system servers 102 and data sources 103 to determine and pay any necessary tolls incurred on the vehicle trip.

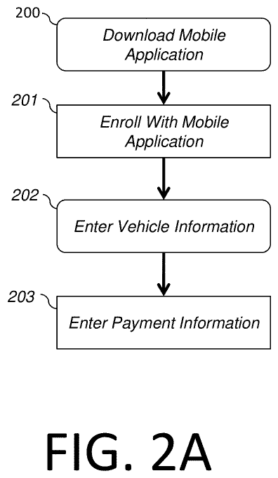

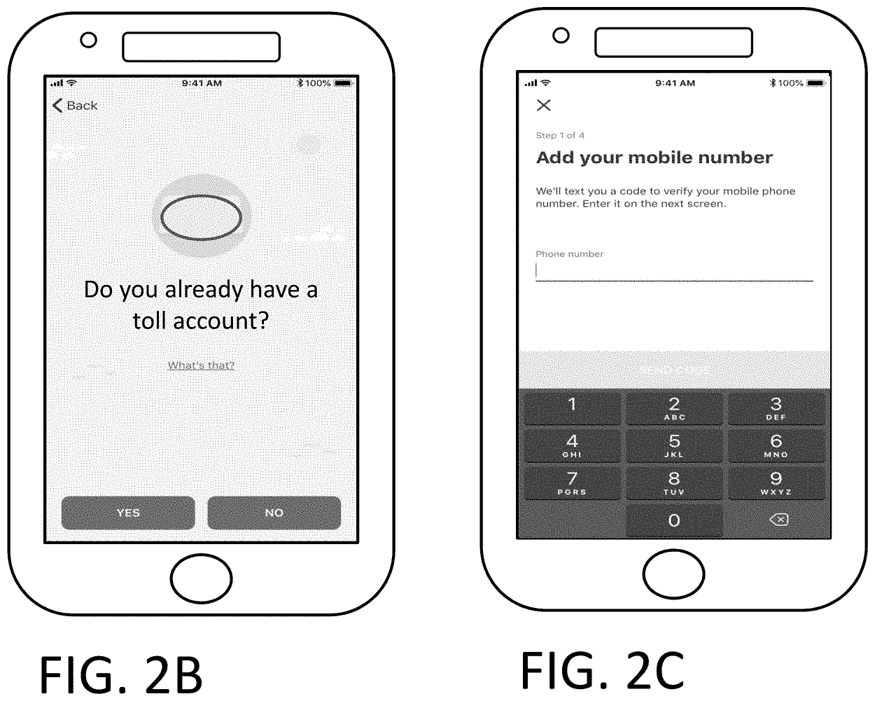

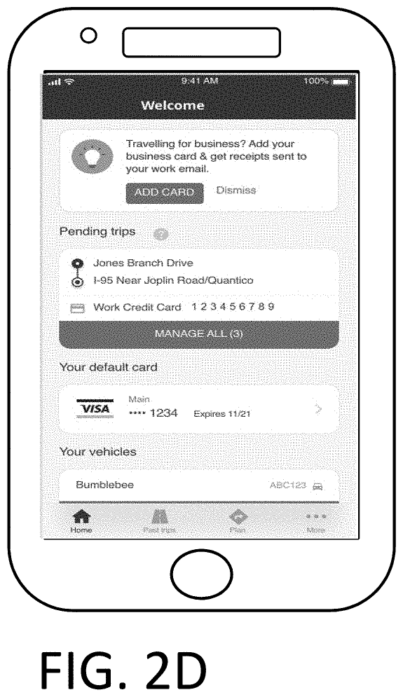

In order to use the mobile tolling system, a user must first download the mobile tolling application to a user mobile device and set up an account with the mobile tolling system. As shown in FIG. 2A, a user first downloads 200 the mobile tolling application to the user device. Once the mobile application is downloaded, a user can select to execute the mobile application on the mobile device and may be presented with user interfaces in the mobile apparition to enroll 201 in the mobile tolling service. To enroll in the mobile tolling application 201, the mobile application may direct the user to enter information such as user name, phone number, email address, and mailing address. Users may also select a user name and password for use in the mobile application. Once a user is registered, the user may enter vehicle information 202 into the mobile application to link vehicles to the user account. The entered vehicle information 202 may include, for example, one or more of vehicle make and model, color, license plate number, and insurance information. In particular, the vehicle license plate number will be stored as part of the vehicle information, as license plate number is commonly captured by tolling authorities to determine which vehicles should be charged a toll. The mobile application may transmit information regarding the user registration and license plate number or other vehicle information to appropriate tolling authorities and agencies for registration at those tolling authorities and agencies. In this way, the tolling authorities can register the vehicle and license plate number as being associated with the mobile tolling service, such that the vehicle tolls may be charged and collected through the mobile tolling service. This registration of the user and vehicles with the appropriate tolling authorities may be sent directly from the mobile application, or can be transmitted from the mobile tolling system servers. Finally, to complete the registration process, users input payment information 203. This payment information may be, for example, a credit card number, bank account number, electronic payment service information, or any other financial account that can disperse funds to pay for user incurred tolls.

During the enrollment 201 and entry of vehicle information 202, the user may be shown an interface containing a map to pictorially show the user which areas, such as states or highways, will be covered for toll payment through the mobile application. These maps may be color coded to indicate which areas are covered, and which are not. Moreover, during the registration process, users may be presented a list of covered tolling areas, such as states, highways, roads, and bridges, and a status of each of these tolling areas within the mobile tolling system. The presentation of covered tolling areas and rolls may be provided to the user as part of a map display. For example, the user may be provided an interactive map interface of a particular country, state, or other geographic area. Areas on the interactive map, or particular roadways, may be represented with a visual indicator conveying information as to whether the area or particular road is a covered tolling area. For example, States that accept payment through the mobile tolling application may be represented in a particular color, or have an icon displayed thereon to designate acceptance. This list and status of covered areas and roads will also be available to the user within the application after registration, and may be kept up-to-date with real-time information. For example, when the user logs in to the application after registration, they may be presented with a visual interface, such as a map or listing, indicating which states, roads, and areas are covered, and the status of each tolling area. Users may also be presented with the visual representation of covered tolling areas and status of such areas during route planning within the mobile app. For example, when a user plans a route, the application may display various route options, along with indications of which states, roads, and other areas would be covered by the mobile tolling application, and which would not. In addition, the user interface may display notifications of promotional offers related to using the tolling system, such as discounted tolls or credits along certain routes or at certain toll locations.

The mobile application may show users a current status, indicating where mobile tolling service has registered their vehicle. Users may select to register different vehicles to the same account, such that user can select which vehicle they are traveling in when they open and implement the mobile tolling application. Moreover, when different users share the same vehicle, multiple users can register the same license plate number to their accounts. When a vehicle with a license plate registered to multiple users passes through a toll location, the mobile tolling system may place a toll charge on the account of all users registered to that license plate if it is unable to determine which user was driving. The system may notify the users registered to the license plate of the charge, and provide an option for the users to select which user should be charged. Once payment is received from one user, the system may remove the toll charge from any other users who were also charged. In situations where multiple users are registered to the same license plate, the system may recognize which user to charge by receiving detected location information from the mobile applications on each user's mobile devices. For example, if a user either has the mobile application at the time the vehicle incurs the toll charge, or opens the mobile application at a later time, the system may retrieve the location information for the user and determine whether the location information for the user matches the toll charge location information. If only user appears to have been at the location the toll charge was incurred at the time of the toll charge, then the charge may be sent only to that user's account. If multiple users are in the same car, such that multiple users were at the location of the toll charge, then the system may allow the users to select which user will pay the incurred toll charge as described above.

FIGS. 2B-2C show various user interfaces of the mobile application that may be presented to the user during the registration process. For example, FIG. 2B indicates that the enrollment process may ask a user to provide information on existing toll accounts they may have, such as an EZ-PASS account. If a user has such an account, the mobile tolling application may then register the user with the tolling authority overseeing the existing toll account so that tolls may be paid to that tolling authority through the mobile application. FIG. 2C illustrates an interface for inputting user information, such as a phone number, to create the user account. Similar interfaces may be provided for inputting other user and vehicle information. FIG. 2D illustrates a user interface that may be presented to a user after enrollment is complete and the user logs in the mobile tolling application. As shown in FIG. 2D, the mobile tolling application may provide an interface showing user payment methods, pending trips, registered vehicles, and past trips. The mobile application may also provide users with a trip planning interface, allowing them to plan routes from a starting to an ending location and check real-time toll pricing for each different potential route generated. As mentioned above, this trip planning interface may include a visual representation of covered tolling areas and roads. Users may be given the option to select a route and prepay the determined tolls before starting the trip. Users may also select to prepay a certain amount or subscribe to a recurring payment within the mobile application, thus establishing a user account balance within the mobile application. The mobile application and mobile tolling system may then use this prepaid amount or current balance a user has within the mobile application to pay for tolls incurred by the user.

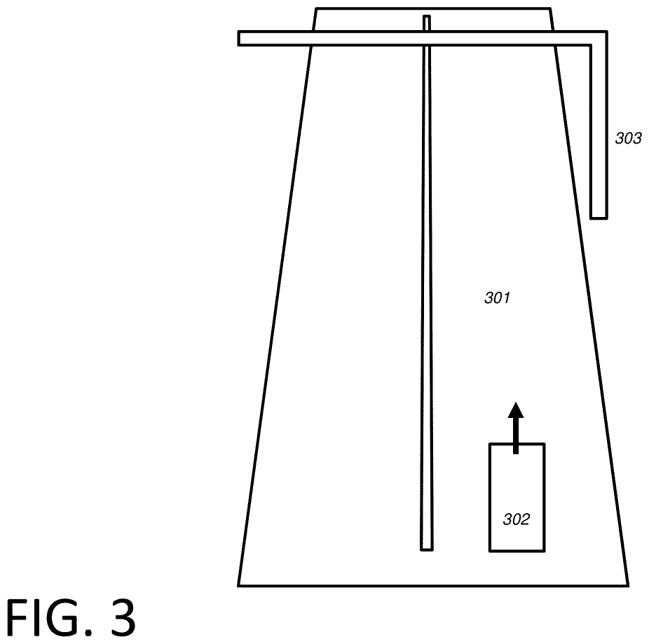

As shown in FIG. 3, the mobile tolling application may allow users to pay tolls in asset transactions, where a particular toll amount at a set location is charged. These asset transactions may be conducted at, for example, highway toll booths, bridges, on-ramps or off-ramps, or electronic tolling gantries. As a user having a user device operating the mobile application travels along a road 301 in a vehicle 302, the vehicle may approach as set tolling location 303 such as an electronic toll gantry. The tolling location 303 may be run by a third-party tolling authority or agency. When the vehicle passes the tolling location, the vehicle license plate may be recorded or the vehicle otherwise identified. The mobile tolling application and system may determine the appropriate tolling authority operating the tolling location 303, and check to determine whether the tolling authority cooperates with the mobile tolling system. For example, the system may check vehicle license plate registration information to determine if the tolling authority participates in transactions with the mobile tolling application and system. If the mobile tolling system participates with the mobile tolling system, then the mobile tolling system may assign a transaction to the user running the mobile tolling application, and complete a payment for the appropriate toll at the tolling location 303 to the tolling authority. In order to determine the appropriate toll pricing, which agency operates the tolling location, and other information, the mobile tolling system may use a web scraper and application programming interface to receive real time information.

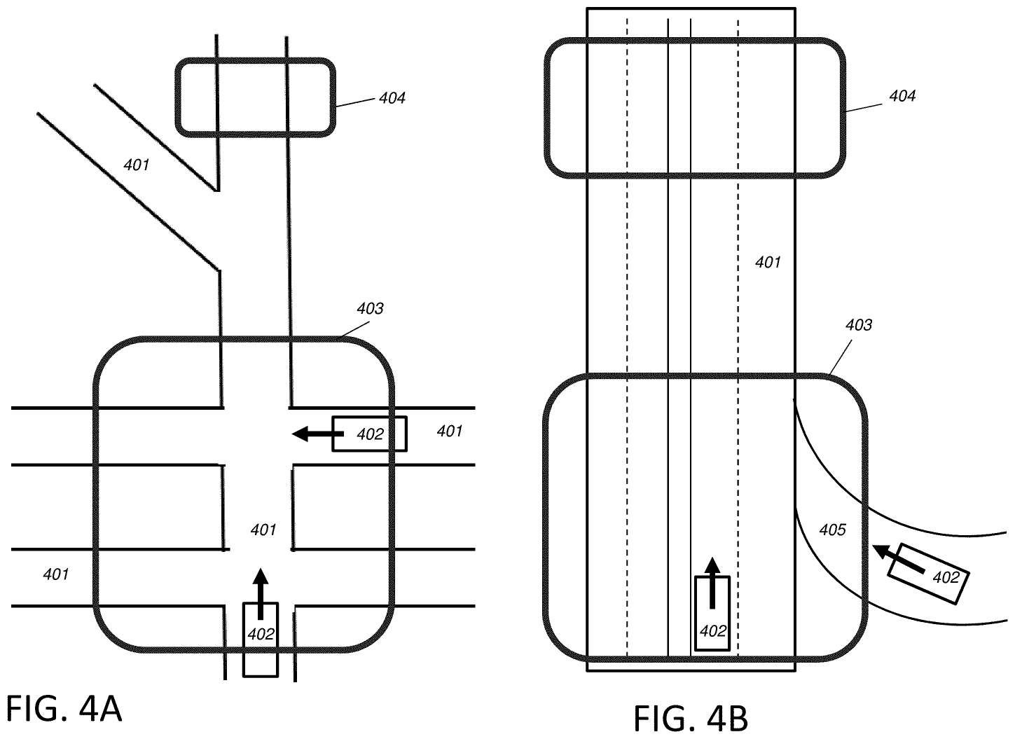

As shown in FIGS. 4A and 4B, the mobile tolling application and system may also conduct tolling transactions for a user based on location information associated with trips taken by a user. As a vehicle 402 drives along one or more roads 401 or on/off ramps 405, the mobile application run on a user device within the vehicle collects location information from the mobile device. For example, the mobile application may collect location information from a GPS receiver, GLONASS receiver, or other location receiver with the mobile device. The mobile application computes or receives a notification that it has hit a check-in location. For example, the mobile application may receive a list of waypoints, and then as the mobile application tracks movement of the mobile device during a trip, it compares the current location to the list of waypoints. When the mobile application determines that it arrived at or passed a waypoint on the list, it determines that it was at the location of that particular waypoint or check-in and registers a geolocation check-in, indicating that the vehicle was present at one or more locations at a particular time. The mobile device then sends information regarding the check-ins to a mobile tolling system server, which forms routes and toll information based on the received check-ins. In addition, a geolocation validation server may receive location information and determine whether the mobile device entered the check-in zones. The geolocation validation server may be one of the mobile tolling system servers, or may be a third party geolocation validation server that communicates with the mobile tolling application and/or mobile tolling system servers. The mobile application itself may also form the routes and calculate the toll information if it has access to the necessary toll and pricing information. For example, as shown in FIGS. 4A and 4B, predetermined locations 403 and 404 may be associated with areas around one or more sections of roadways or intersections of roads. Based on the location information pulled from the mobile device, the mobile tolling system may determine if a sufficient number of check-ins at different locations were received to form a trip. The mobile tolling system servers, or the mobile tolling application, may form a trip based on the time and location of each of the check-ins and determined locations of the vehicle. The system may then compare the formed trip with tolling information, and determine whether any tolls should be assessed based on the formed trip. The tolling information may include toll pricing pulled from a plurality of sources, such as the mobile tolling system, third-party tolling agencies, internet and web scrapers checking for tolling information and pricing. The system then compares the determined, formed trip that the vehicle took to the tolling information, and assesses any tolls incurred for the formed trip to the user account in the mobile application.

Moreover, the mobile application or a mobile tolling server may collect information from a GPS or other location receiver, and also receive information from roadside tolling capture sensors, such as cameras, RFID systems, and license plate readers. The mobile application mobile tolling service may combine the information from the mobile application, GPS or location receiver, and roadside tolling capture sensors to determine all tolls a user incurred on a particular trip. The mobile tolling system may combine all of this information, and create a single tolling charge, accounting for all tolls incurred, that is charged to the user. The user can then use the system to pay all tolls incurred on a trip in one transaction, rather than authorizing and paying each individually incurred toll. The mobile tolling system may then coordinate payment of the appropriate toll amounts to each tolling authority owed.

Forming the trips for the location-based toll transactions may be based on direction of travel, origin or trip starting point and destination or trip ending point, one or more check-ins at locations along the trip route, timeframe between previous and subsequent trips, and the validity of the license plate or user account. To determine direction of travel, the mobile application or mobile tolling system server may use the captured location information provided by the mobile device, and compare the vehicle location at different times to determine which direction the vehicle is traveling. In addition, the mobile application may check the order in which it registered check-ins at different locations, waypoints, or zones, and use the order of these check-ins to determine direction of travel. The timeframe between trips may be used to limit trip formation. For example, the mobile application and mobile tolling system may require a predetermined amount of time to pass before the system can register a new trip, such that one trip with small stops or pauses does not register as multiple trips. Users may also be charged depending on how frequently they make a trip on, with the toll price changing if the same toll location or charge is incurred within a certain time period.

A geolocation is a valid recognition of a entering the predetermined geolocation zone, with at least validly recognized geolocations forming a trip. To determine whether a vehicle has entered a predetermined geolocation zone, geofences may be drawn on a map of roadways in the area where the location information from the mobile device operating the mobile tolling application will be collected. The mobile tolling application, or the mobile tolling system server or a third party server receiving the mobile device location information, determines whether the vehicle has crossed into the geofenced areas. When it is determined that the vehicle has cross into a geofenced area, then a valid geolocation is registered. The geofences, such as areas 403 and 404 shown in FIGS. 4A and 4B, drawn on the maps of roads should not overlap each other, and must be of sufficient size to account for high speed driving. That is, the geofence areas must be long enough that the mobile device will be able to capture location information within the geofence area sufficient to validate that the vehicle entered the geofence area, even when the vehicle is traveling at high speed. Similarly, the geofence areas should not overlap in the direction a vehicle may travel, so that separate determinations that a vehicle has entered the separate geofence areas can be made. If the geofence areas overlap, then the system may not be able to determine whether a vehicle location in the overlap region was at the locations defined by both geofences, or on the location defined by one of the geofences. For a valid trip, the mobile tolling application or mobile tolling system servers may detect that a vehicle entered at least two geofence areas in the correct order and within a predetermined time period.

Referring to FIG. 4A for example, a valid trip may be formed if a vehicle 402 is determined to have entered geofence area 403 and subsequently geofence area 404 within a predetermined time period. This indicates that the vehicle made a trip between a location within geofence area 403 to a location within geofence area 404. If the order is not correct, or if the vehicle enters the two geofence areas outside of a predetermined time period, then no valid trip is formed. The predetermined time period helps to ensure that trips are not formed, and toll charges not incurred, if a vehicle enters the different geofence areas as part of separate trips.

The geofence concept may also be applied to rental car agencies using the mobile tolling system. For example, the mobile tolling application may track the vehicles location, and geofencing zones may be set up at the rental car pick up and return locations. When a user picks up a rental car, they may be provided with an option to use the mobile tolling application and system to pay tolls. In addition, the mobile tolling system will capture locations of the vehicle, including whether and when it has entered into geofenced areas. Where a geofence area is set up at the rental car return location, the system can track when the user returns the car. When the system determines, based on GPS information, that the rental car has entered into the geofenced area of the return location, it can create a record of the time and date of such return. In this way, the system can use this return time as a cutoff for when tolls incurred by the vehicle should be charged to the previous renter. That is, from the time the car renter leaves a geofenced area designated around a rental car pick up location until the time the car renter enters the geofenced area designated around a return location, the system can charge all tolls incurred to that renter. After the vehicle has been returned, the system may reset the tolling obligations such that they are no longer associated with the prior renter.

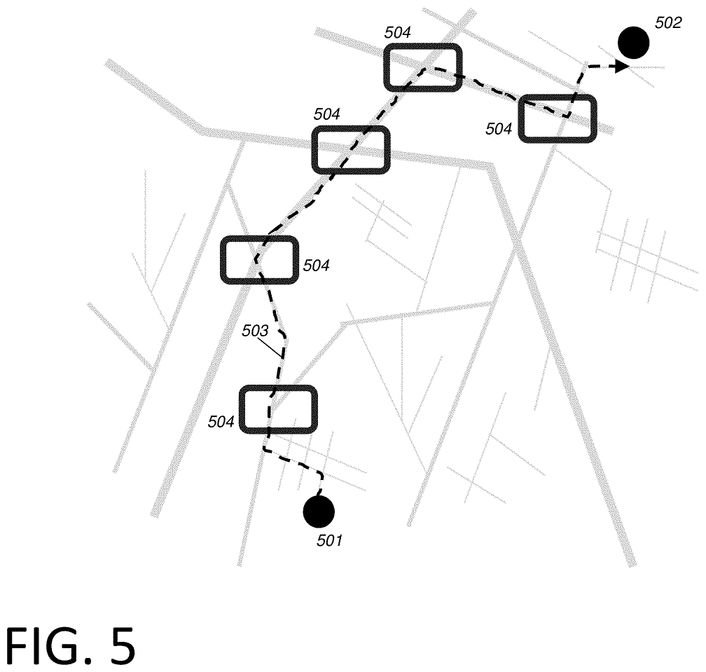

FIG. 5 illustrates an example of a formed vehicle trip, with a vehicle starting at location 501 and ending at location 502. As shown, the vehicle is determined to have traveled on path 503 as shown overlaid on a road map. Geofence zones 504, also shown overlaid on the road map, provide for detecting check-ins of the vehicle at different locations along the route. As seen in FIG. 5, the system would register valid vehicle check-ins in each of the geofence zones 504 as the vehicle travels from the start location 501 to the end location 502. Based on the start location, location check-ins, and end location, the mobile tolling application and mobile tolling system servers form the trip taken, and calculate the appropriate toll by pulling toll pricing for all road segments along the formed trip. As noted, a trip may also be formed of a single check-in, with the tolling incurred based on the vehicle entering that check-in location.

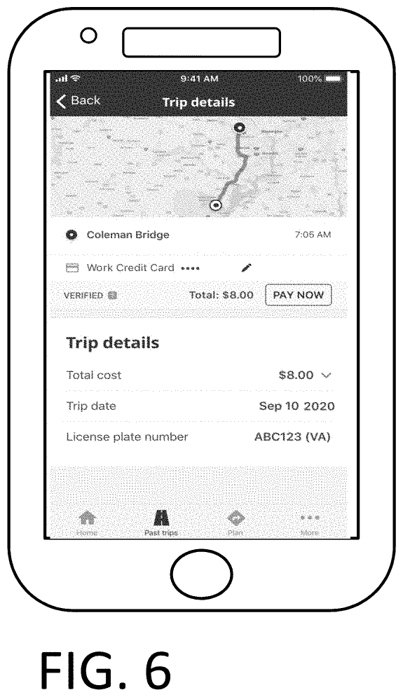

FIG. 6 illustrates a user interface that may be provided to a user within the mobile application following completion of a trip. As shown in FIG. 6, the user interface may indicate trip date and time, vehicle license plate or other vehicle information associated with the trip, credit card or payment source to be used, toll charges incurred, and a map showing details of the trip taken. The user interface may further provide the user with an option to pay the incurred tolls. If the user selects to pay the tolls incurred, the mobile application would initiate a payment transaction between the user and the tolling authority responsible for the incurred tolls, or between the user and the mobile tolling system, which would then ensure payments are made to the appropriate tolling authority on behalf of the user. Users may also prepay or set a recurring payment within the mobile tolling application, such that the user maintains an account balance with the mobile application tolling system. The user may select to automatically pay incurred tolls from this account balance, or to have incurred tolls automatically charged to the payment source (such as a credit card) selected by the user within the mobile application. When automatic payment selection is activated, the mobile application may not require manual selection or authorization from the user within the application to pay tolls for each transaction.

In order to ensure that the drawn geofence check-in locations that will be used to determined formed trips are valid, the system may include an automation program to simulate trips on the maps of roads on which the geofences are drawn. The system may simulate vehicle traffic along the roads on the map of roads, and check to ensure that vehicle check-ins are registered for the simulated vehicles as they enter into the geofence areas. In the simulation, the path of the vehicles may be defined by location information of the type that will be retrieved by the mobile device, such as GPS coordinates or locations. As the simulated vehicles travel along the path, the simulated vehicle location information for the path is checked against the geofence zones. When the simulated vehicle enters a geofence area on the map, a check-in is determined for that location and sent to the mobile tolling application or mobile tolling system servers. The check-ins from the simulated vehicles are used to form the trip, and the system compares the formed trip to the expected trip based on the simulation parameters. If the formed trip matches the expected trip, then the system validates that the trip was formed properly. Once the system sufficiently validates the trip, then the geofence areas forming the check-ins may be validated and used to drawn check-ins used in the mobile tolling application. As part of the simulations, physical movement of a mobile device that would be in a vehicle taking the simulated trip may be simulated. For example, simulated signals from an accelerometer sensor within the mobile device may be used during the trip simulations such that the mobile device does not enter into a sleep mode or otherwise determine it is not moving, which could cause problems with properly capturing the simulated trips.

The mobile tolling application system may also include a replay functionality that captures data related to trips taken by users of the mobile application as they travel different routes. This data related to trips taken can include, for example, roads traveled, traffic flow at different times of day and days of the week, physical toll locations passed, electronic or location-based tolls incurred, toll prices for each particular trip, tolling authorities paid based on the trip, and starting and ending locations. Using this captured data, the system may replay trips taken and make adjustments to, for example, roads traveled and time of day, and determine whether an alternative trip route may have been faster or incurred less toll charges. The system can also use analysis of replayed trips to determine if any changes in toll rates may be beneficial. The replayed trip information can additionally be used to simulate real-world trips as part of validating new check-ins as described above. Moreover, the replayed trips may be used to help generate potential routes for users as part of the trip planning feature in the mobile tolling application.

As noted above, the system may also include a trip planning feature allowing users to plan routes and view the estimated tolling charges for each route. Referring again to FIG. 5, the system may allow a user to pull up a map display of roads, and enter an input location 501 and end location 502. The system may use databases of roads making up the road maps to generate potential routes between location 501 and 502. The system may further search for tolling locations, check-ins, and traffic along the routes, and validate whether the potential routes traverse any locations where tolls would be incurred. The system may allow a certain distance to be traveled on a given road before a toll charge is incurred, or may calculate a different toll rate based the distance a vehicle travels on a road, and can take into these distances when provided planned trip routes. For example, a route that travels on a toll road for 10 miles may have a different estimated toll rate than a route that travels on the same toll road for 20 miles. In determining the estimated pricing, the system may pull toll information from a plurality of sources in order to assess all tolls that may be incurred on each potential route. For example, the system may consider tolls that would be charged by various tolling authorities and aggregate all tolls into a final estimate toll cost for each route. The mobile application may provide the users with an option to pre-pay tolls that will be incurred on the planned route, or may provide an option to pay tolls after the route has been traveled and the trip verified.

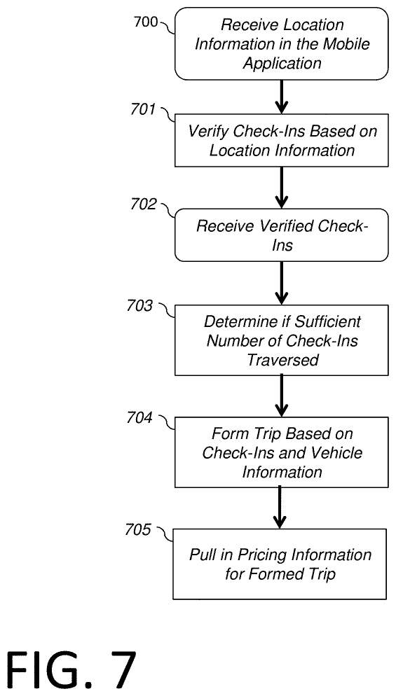

FIG. 7 provides a flow diagram of the process in the mobile tolling system for generating location based tolling transactions, such as described above with respect to FIGS. 4A, 4B, and 5. As shown in FIG. 7, the mobile tolling application first receives location information 701 from the mobile device executing the application. For example, where the mobile application is running on a mobile phone having a GPS receiver, the mobile application may access the GPS receiver of the mobile phone to pull GPS locations and coordinates. The mobile application then itself determines whether it has entered into a check-in zone, or sends the received location information to a check-in verification server at 702. The mobile application or check-in verification server determines whether valid check-ins at predetermined locations, such as geofence zones, were made based on the received location information. The mobile tolling system then receives verified check-ins from the mobile application or check-in verification server 702, and determines if a sufficient number of check-ins were received at 703. If a sufficient number of check-ins have been received at 703, then the system forms a trip 704 based on the check-ins and vehicle information associated with the mobile application providing the location information. This vehicle information may include, for example, license plate number or user account, vehicle name, time of day, and duration of trip. The system then pulls in toll pricing information to the formed trip 705. This pricing information can be pulled from a plurality of sources, including the mobile tolling system's own databases, databases of third-party tolling agencies or authorities, and websites and digital sources of toll pricing. The mobile tolling system server or mobile application may receive this pricing information to present tolling pricing to the users. Once the pricing information has been determined, the incurred toll charges may be presented to the user and the user given different options to pay the tolls.

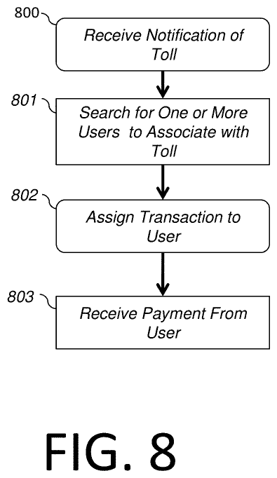

FIG. 8 provides a flow diagram of the process in the mobile tolling system for asset transactions of paying tolls to individual tolling agencies, such as tolls paid to a tolling agency operating an electronic tolling gantry along a highway as shown in FIG. 3. As shown in FIG. 8, the mobile tolling application or mobile tolling system receives a notification of a toll charge 800 incurred by a user of the mobile application. This notification may come from an internal database that stores known toll locations, or may be communicated from a tolling authority responsible to operating the toll location. For example, if a tolling agency captures a vehicle license plate at a tolling location, this captured license plate may be checked in a database to determine if the license plate is enrolled in the mobile tolling payment system. If it is, the tolling agency may send a notification to the mobile application or mobile tolling system to alert that a toll has been incurred. Once the notification of a toll has been received, the system may search for a user to associate with the toll 801. For example, the system may check the identified license plate number of the vehicle that incurred the toll, and determine whether that license plate number is associated with a registered mobile application user. The system may also check to see if the license plate number is associated with the tolling agency charging the toll in order to ensure that the mobile tolling system can enter into transactions with that agency. Once a registered mobile tolling application user associated with the toll is identified, the system assigns the toll transaction to that user 802, notifying the user of the incurred toll charge. The system then receives payment from the user for the incurred toll 803 to complete the tolling transaction.

We hereby claim:

1. A method for determining and processing vehicle toll payments, comprising:
receiving location information from a mobile device, the location information being received in a mobile application executed on the mobile device;
verifying check-in locations of the vehicle based on the location information from the mobile device;
receiving verified check-ins;
determining the number, location, and order of the received check-ins;
forming a trip based on the received check-ins; and
determining toll pricing information based on the formed trip.

2. The method of claim 1, further comprising receiving vehicle information, and determining toll pricing based on the formed trip and the vehicle information.

3. The method of claim 1, further comprising receiving a list of waypoints within a map database, and wherein verifying check-in locations comprises comparing location information from the mobile device to the list of check-in locations.

4. The method of claim 3, wherein the list of waypoints comprise geolocation zones, and wherein verifying a check-in comprises determining that the location information from the mobile device indicates the mobile device entered into a geolocation zone.

5. The method of claim 1, further comprising presenting the determined toll pricing information to a user, and conducting a payment transaction to pay the determined toll pricing.

6. The method of claim 5, further comprising providing a database of user accounts, wherein the user accounts include information related to at least one vehicle associated with each user account, and determining a user account to be charged based on the vehicle information.

7. A system for determining and processing vehicle toll payments comprising:
a mobile device comprising a processor, location receiver, and computer readable medium coupled to the processor having stored thereon instructions which, when executed by the processor, causes the processor to perform operations comprising:
receiving location information from a mobile device, the location information being received in a mobile application executed on the mobile device;
verifying check-in locations of the vehicle based on the location information from the mobile device;
receiving verified check-ins;
determining the number, location, and order of the received check-ins;
forming a trip based on the received check-ins; and
determining toll pricing information based on the formed trip.

8. The system of claim 7, further comprising a database of vehicle information accessible to the processor, and wherein the processor is configured to determine toll pricing based on the formed trip and the vehicle information.

9. The system of claim 7, further comprising a map database containing waypoint locations, wherein the processor is further configured to receive a list of waypoints from the map database, and wherein verifying check-in locations comprises comparing location information from the mobile device to the list of check-in locations.

10. The system of claim 9, wherein the list of waypoints comprise geolocation zones, and wherein verifying a check-in comprises determining that the location information from the mobile device indicates the mobile device entered into a geolocation zone.

11. The system of claim 7, further comprising a user interface on the mobile device, the user interface configured to display the determined toll pricing information to a user.

12. The system of claim 11, further comprising a database of user accounts, wherein the user accounts include information related to at least one vehicle associated with each user account, and determining a user account to be charged based on the vehicle information.
